(19) United States
(12) Patent Application Publication
(10) Pub. No.: US 2015/0055190 A1
(43) Pub. Date: Feb. 26, 2015

(54) COMMUNICATION APPARATUS, CONTROL METHOD THEREOF, AND STORAGE MEDIUM

(71) Applicant: CANON KABUSHIKI KAISHA, Tokyo (JP)

(72) Inventor: Kaori Nakagawa, Yokohama-shi (JP)

(21) Appl. No.: 14/337,533

(22) Filed: Jul. 22, 2014

(30) Foreign Application Priority Data
Aug. 21, 2013 (JP) 2013-171708

(51) Int. Cl. H04L 29/06; H04N 1/00

(52) U.S. Cl. CPC H04L 65/1069; H04L 65/1006; H04N 1/00095
USPC 358/425

(57) ABSTRACT

There is provided a technique of enabling an operator to confirm partner information in a communication apparatus capable of executing FAX transmission via an IP network, without mounting a new function in a partner apparatus in FAX transmission. To achieve this, when a communication apparatus (IP FAX 1) accepts input of partner information representing a partner apparatus (IP FAX 2) in the FAX transmission via an IP network, it transmits an SIP session establishment request to the partner apparatus. When the communication apparatus receives a response to the session establishment request from the partner apparatus, it prompts an operator to confirm partner information contained in the response before the start of the FAX transmission.

### BACKGROUND OF THE INVENTION

1. Field of the Invention

The present invention relates to a communication apparatus which performs communication on an IP network by using SIP (Session Initiation Protocol), a control method thereof, and a storage medium.

2. Description of the Related Art

With the popularization of the Internet and IP telephone, a method using an IP network as a communication path of facsimile (FAX) communication is being established in recent years. For example, there is a deemed voice scheme in which a G3 FAX (T.30) signal is digitized and transmitted on an IP network by using VoIP (Voice over IP). The ITU-T has recommended the T.38 scheme in which a G3 FAX (T.30) signal is converted into an IP message by using a protocol called IFP (Internet Facsimile Protocol), and the IP message is transmitted in real time on an IP network. A facsimile apparatus using the IP network is called an “IP facsimile (IP FAX)”. The IP FAX utilizes SIP (Session Initiation Protocol) in which generation, change, and disconnection of a session for real-time communication are performed. By this technique, the IP FAX designates a transmission partner by a telephone number, and performs real-time facsimile communication on an IP network by using the T.38 scheme.

The IP FAX can designate a transmission partner by a telephone number. If the operator erroneously inputs transmission partner information, the IP FAX may transmit image data of an important document or the like to a partner not intended by the operator. As a technique for coping with this disadvantage, Japanese Patent Laid-Open No. 2006-100966 has proposed a technique of displaying transmission partner information before FAX transmission to prompt the operator to confirm the transmission partner. More specifically, before an SIP call connection, a command in the text format based on a MESSAGE method is transmitted to a partner apparatus to acquire identification information of the partner apparatus and display the acquired partner information. The user can confirm whether the displayed partner information is information of a partner intended by the user. This prevents in advance a transmission error of image data to a partner apparatus not intended by the user.

However, the above-described related art requires processing of acquiring identification information from a partner apparatus by the MESSAGE method in order to confirm identification information of a transmission partner. To implement this, both apparatuses on the transmitting and receiving sides need to support a function of executing this processing. In cases where identification information to be transmitted by the MESSAGE method is erroneously registered in an apparatus on the receiving side, or cases where identification information itself has not been registered, an apparatus on the transmitting side cannot appropriately acquire identification information (partner information) from the apparatus on the receiving side.

### SUMMARY OF THE INVENTION

The present invention has been made to solve the above-described problems. The present invention provides a technique of enabling, in a communication apparatus capable of executing FAX transmission via an IP network, an operator to confirm partner information without mounting a new function in a partner apparatus in FAX transmission.

According to one aspect of the present invention, there is provided a communication apparatus capable of executing SIP facsimile (FAX) transmission via an IP network, comprising: an acceptance unit configured to accept, from an operator, input of partner information representing a partner apparatus in the FAX transmission via the IP network; a transmission unit configured to transmit an SIP session establishment request via the IP network to the partner apparatus represented by the input partner information; and a confirmation unit configured to, in a case where a response to the session establishment request is received from the partner apparatus, prompt the operator to confirm partner information contained in the response before a start of the FAX transmission.

According to another aspect of the present invention, there is provided a method of controlling a communication apparatus capable of executing SIP facsimile (FAX) transmission via an IP network, comprising steps of: accepting, from an operator, input of partner information representing a partner apparatus in the FAX transmission via the IP network; transmitting a session establishment request by SIP via the IP network to the partner apparatus represented by the input partner information; and in a case where a response to the session establishment request is received from the partner apparatus, prompting the operator to confirm partner information contained in the response before a start of the FAX transmission.

According to still another aspect of the present invention, there is provided a computer-readable storage medium storing a computer program for causing a computer to execute steps of a method of controlling a communication apparatus capable of executing SIP facsimile (FAX) transmission via an IP network, comprising steps of: accepting, from an operator, input of partner information representing a partner apparatus in the FAX transmission via the IP network; transmitting a session establishment request by SIP via the IP network to the partner apparatus represented by the input partner information; and in a case where a response to the session establishment request is received from the partner apparatus, prompting the operator to confirm partner information contained in the response before a start of the FAX transmission.

The present invention enables, in a communication apparatus capable of executing FAX transmission via an IP network, an operator to confirm partner information without mounting a new function in a partner apparatus in FAX transmission.

Further features of the present invention will become apparent from the following description of exemplary embodiments (with reference to the attached drawings).

### BRIEF DESCRIPTION OF THE DRAWINGS

FIG. 1 is a block diagram showing the arrangement of an IP FAX apparatus according to an embodiment of the present invention;

FIG. 2 is a sequence chart showing call connection processing in the IP FAX apparatus according to the embodiment of the present invention;

FIG. 3 is a view showing an example of the header portion of an SIP message transmitted/received in call connection processing in the IP FAX apparatus according to the embodiment of the present invention;

FIG. 4 is a view showing an example of a confirmation screen displayed on the IP FAX apparatus according to the embodiment of the present invention;

FIG. 5 is a flowchart showing the procedures of call connection processing in the IP FAX apparatus according to the embodiment of the present invention; and

FIGS. 6A and 6B are flowcharts showing the procedures of FAX communication processing (step S208) in the IP FAX apparatus according to the embodiment of the present invention.

### DESCRIPTION OF THE EMBODIMENTS

Hereinafter, embodiments of the present invention will be described in detail with reference to the accompanying drawings. It should be noted that the following embodiments are not intended to limit the scope of the appended claims, and that not all the combinations of features described in the embodiments are necessarily essential to the solving means of the present invention.

<Arrangement of IP FAX Apparatus>

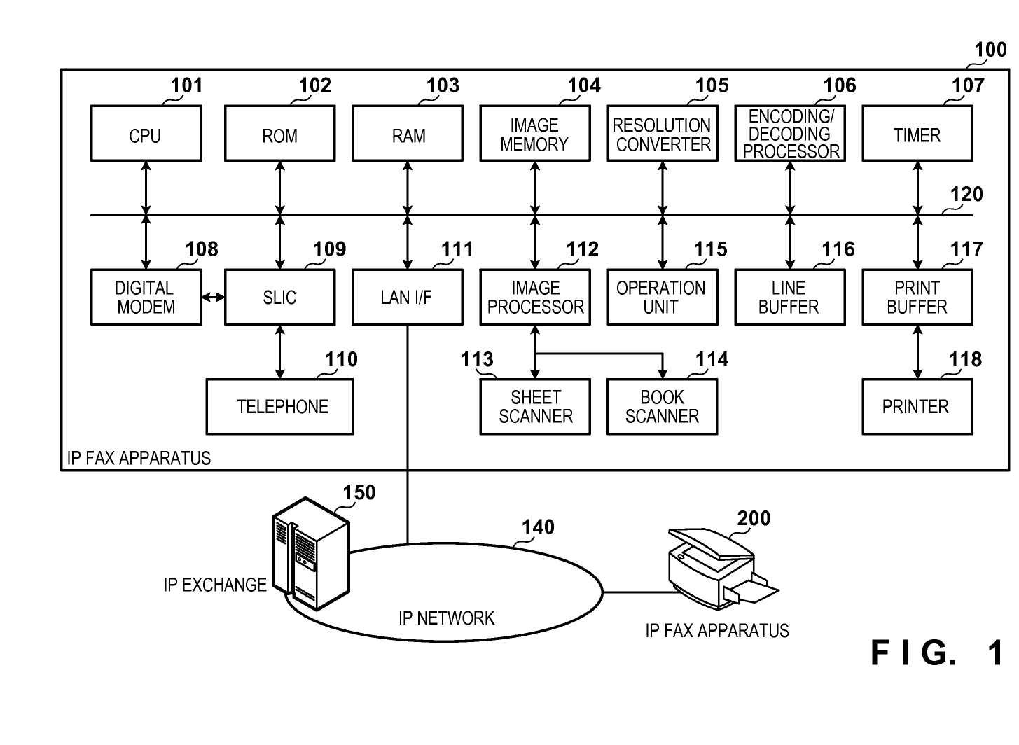

FIG. 1 is a block diagram showing an example of the arrangement of an IP facsimile (IP FAX) apparatus 100 according to the embodiment of the present invention. Assume that the IP FAX apparatus 100 and an IP FAX apparatus 200 have the same arrangement. As shown in FIG. 1, the IP FAX apparatus 100 (IP FAX 1) is connected to the IP FAX apparatus 200 (IP FAX 2) via an IP network 140. The IP network 140 is a network in which IP-based communication is performed, such as a private IP network or NGN. An IP exchange 150 is connected to the IP network 140. The IP exchange 150 performs SIP call control to perform exchange processing between the IP FAX apparatuses 100 and 200 connected to the IP network 140. In the embodiment, the IP FAX apparatuses 100 and 200 are examples of communication apparatuses capable of executing SIP facsimile (FAX) transmission via an IP network.

The IP FAX apparatus 100 includes a CPU 101, ROM 102, RAM 103, image memory 104, resolution converter 105, encoding/decoding processor 106, timer 107, digital modem 108, SLIC (Subscriber Line Interface Circuit) 109, telephone 110, LAN interface (I/F) 111, image processor 112, operation unit 115, line buffer 116, and print buffer 117. These devices are connected to each other via a system bus 120. The IP FAX apparatus 100 further includes the telephone 110 connected to the SLIC 109, a sheet scanner 113 and book scanner 114 connected to the image processor 112, and a printer 118 connected to the print buffer 117.

The CPU 101 is a system control unit, and controls the overall IP FAX apparatus 100. The ROM 102 stores the control program of the CPU 101. The RAM 103 is implemented by an SRAM or the like, and stores data which need to be backed up, such as setting information of the IP FAX apparatus 100 and management information of image data. The image memory 104 is implemented by a DRAM or the like, and stores image data to be processed by the IP FAX apparatus 100.

The resolution converter 105 performs resolution conversion processing such as milli-inch resolution conversion of raster data. The encoding/decoding processor 106 for reading and recording performs encoding processing and decoding processing of image data to be processed by the IP FAX apparatus 100. The timer 107 is implemented by an IC or the like, and is used by an application which measures the time.

The digital modem 108 transmits, to the IP network 140 via the LAN I/F 111, a digital signal generated by modulation using a control signal and image data transmitted from the IP FAX apparatus 100, and voice encoding such as G.711.

The SLIC 109 performs analog/digital conversion and telephone line emulation by voice encoding such as G.711. The telephone 110 is a telephone such as a handset or phone-answering machine used for voice communication. The telephone 110 may be arranged inside the IP FAX apparatus 100, as shown in FIG. 1, or outside it. The SLIC 109 has a function of emulating line connection processing via a telephone line, such as generation of call signals and various tone signals on a telephone line (exchange). With this function, the SLIC 109 can connect the telephone 110 to the IP network 140 without the intervention of a telephone line. When the SLIC 109 receives an off-hook signal and selection signal from the telephone 110, it notifies the CPU 101 that the SLIC 109 has received these signals.

The LAN I/F 111 functions as an interface for the IP network 140, and controls communication with an external apparatus, such as the IP FAX apparatus 200, connected to the IP FAX apparatus 100 via the IP network 140. The image processor 112 outputs higher-resolution image data by performing correction processing on image data obtained by reading by the sheet scanner 113 or book scanner 114. Each of the sheet scanner 113 and book scanner 114 includes a CS image sensor and original conveyance mechanism, optically reads the image of an original, converts it into electrical image data, and outputs the image data. Note that both of these scanners can read a double-sided original.

The operation unit 115 includes an input device such as a keyboard or touch panel, and a display device (display unit) which displays various kinds of information. The operation unit 115 functions as a user I/F for an operator (user). In the embodiment, the display device displays partner information such as a partner telephone number in a connection confirmation mode (to be described later). The operator can confirm displayed partner information and input, via the input device, permission/inhibition (whether or not to permit FAX transmission) of connection to a partner apparatus corresponding to the partner information.

The line buffer 116 is used to buffer data of one line when performing transfer control of image data. The print buffer 117 is used to buffer data of one page in image data to be printed when printing by the printer 118. The printer 118 prints, on a sheet such as plain paper, an image such as a received image by FAX communication. The printer 118 is also capable of double-sided printing.

<Call Connection Processing between IP FAX Apparatuses>

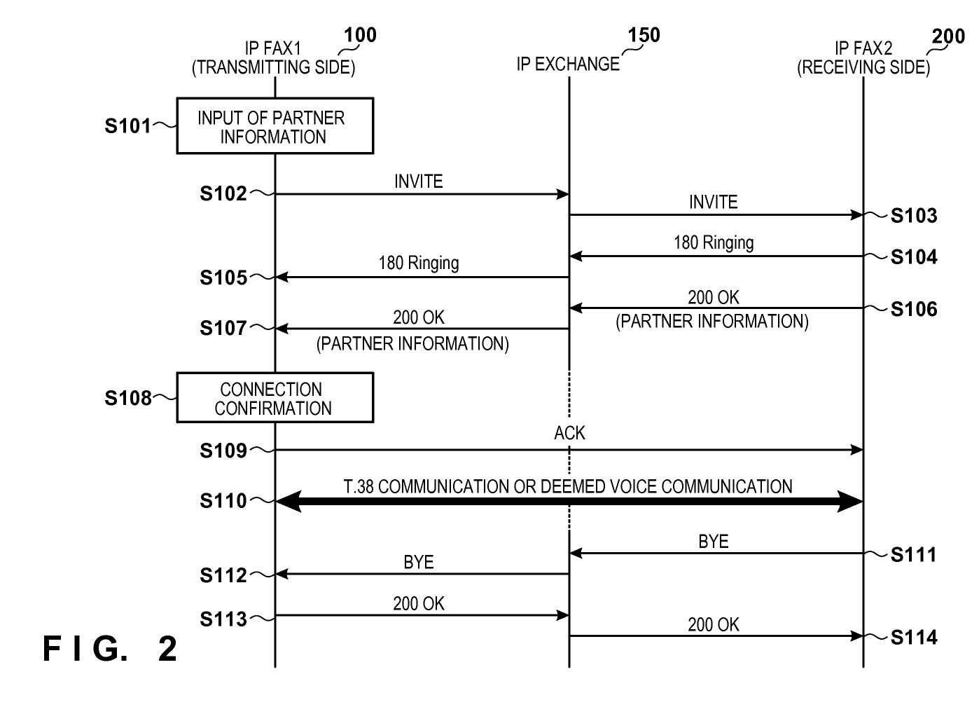

FIG. 2 is a sequence chart showing call connection processing between the IP FAX apparatus 100 (IP FAX 1) and the IP FAX apparatus 200 (IP FAX 2) according to the embodiment. FIG. 2 shows a case in which FAX transmission is performed from IP FAX 1 to IP FAX 2 via the IP network 140. In the embodiment, IP FAX 1 on the transmitting side and IP FAX 2 on the receiving side establish an SIP session and perform FAX communication.

First, in step S101, IP FAX 1 on the transmitting side accepts, from the operator, input of partner information representing a partner apparatus in FAX transmission via the IP network 140. The partner information is identification information of the partner apparatus such as a telephone number or SIP URI corresponding to the partner apparatus. The embodiment assumes that the operator operates the operation unit 115 of IP FAX 1 to input a partner telephone number “044-299-60xx” as the partner information. In step S102, IP FAX 1 transmits an SIP session establishment request (INVITE) via the IP exchange 150 to IP FAX 2 on the receiving side represented by the input partner information.

In step S103, IP FAX 2 on the receiving side receives the session establishment request (INVITE) from IP FAX 1 via the IP exchange 150. In response to the reception of the session establishment request, in step S104, IP FAX 2 transmits, to IP FAX 1 via the IP exchange 150, a provisional response (180 Ringing) representing calling (that is, during processing of the session establishment request). In step S105, IP FAX 1 receives the provisional response (180 Ringing) via the IP exchange 150, and recognizes that IP FAX 2 is calling. In step S106, IP FAX 2 transmits, via the IP exchange 150, a successful response (200 OK) representing that calling has succeeded (that is, FAX transmission can be received). By this response, IP FAX 2 notifies IP FAX 1 that FAX transmission can be received.

Upon receiving the successful response (200 OK) via the IP exchange 150, IP FAX 1 acquires partner information about IP FAX 2 from the received successful response in step S108. Before the start of FAX transmission, IP FAX 1 prompts the operator to confirm whether to actually perform FAX transmission to a partner apparatus represented by the acquired partner information. For example, IP FAX 1 can prompt the operator to confirm partner information by displaying, on the operation unit 115, the telephone number of IP FAX 2 contained in the received successful response (200 OK).

SIP messages which are transmitted from IP FAX 2 to IP FAX 1 and correspond to the provisional response (180 Ringing) and successful response (200 OK) describe information (identification information) representing IP FAX 1 on the transmitting side and IP FAX 2 on the receiving side which are used in actual communication. Thus, IP FAX 1 can acquire, from the provisional response or successful response, information representing IP FAX 2 on the receiving side as partner information.

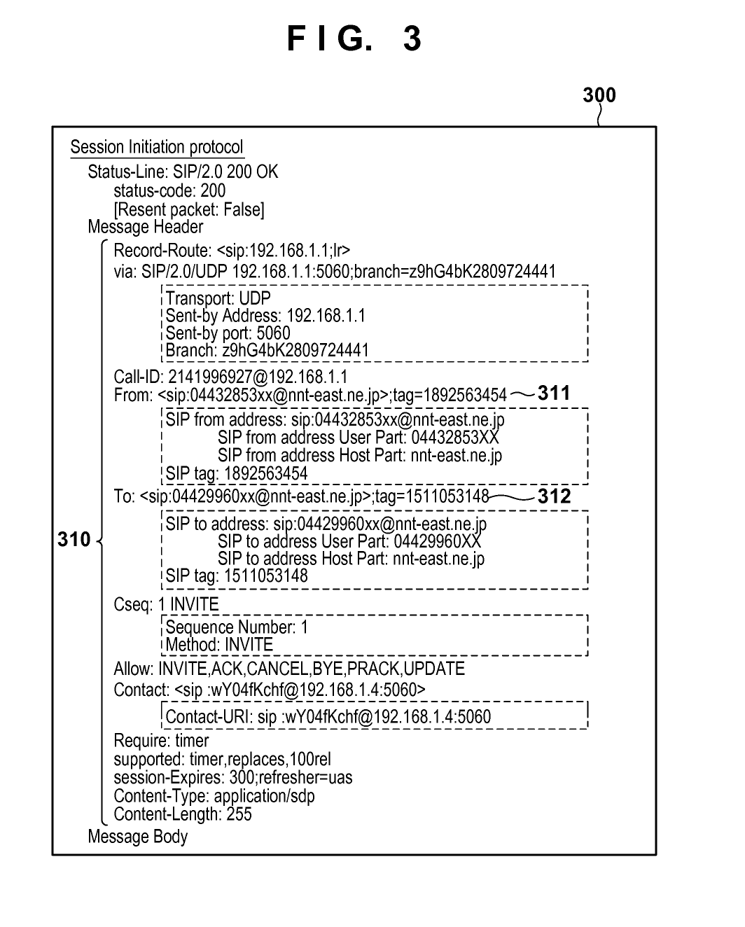

FIG. 3 shows an example of an SIP message 300 which is transmitted from IP FAX 2 to IP FAX 1 in response to the session establishment request (INVITE) and corresponds to the successful response (200 OK). Note that each portion indicated by a broken line represents the description contents of each header field (described immediately before the portion). In a header 310 of the SIP message 300, a From header field 311 represents URI information of IP FAX 1 on the transmitting side, and a To header field 312 represents URI information of IP FAX 2 on the receiving side.

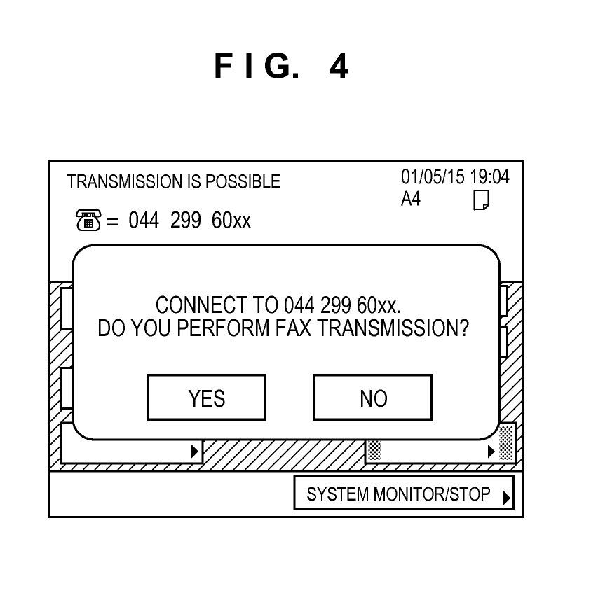

As shown in FIG. 3, the To header field 312 includes the telephone number “044-299-60xx” of IP FAX 2 on the receiving side. In this example, IP FAX 1 acquires this telephone number as partner information. IP FAX 1 displays the acquired partner information on the operation unit 115, for example, as shown in FIG. 4, and can prompt the operator to confirm the partner information. Before FAX transmission, the operator can confirm whether or not the input partner information is correct (that is, whether or not the partner is one intended by the operator).

If the operator permits execution of FAX transmission by an operation input via the operation unit 115 (for example, “YES” is selected on the screen shown in FIG. 4) in step S108, IP FAX 1 transmits an acknowledgement (ACK) to IP FAX 2 in step S109. As a result, a session is established between IP FAX 1 and IP FAX 2. In step S110, IP FAX 1 starts execution of FAX transmission to IP FAX 2 by the T.38 scheme or deemed voice scheme in the established session.

After the end of FAX transmission from IP FAX 1 to IP FAX 2, IP FAX 2 transmits a disconnection request (BYE) to IP FAX 1 via the IP exchange 150 in step S111. In response to this, IP FAX 2 notifies IP FAX 1 that reception of FAX transmission by the T.38 scheme or deemed voice scheme has ended. If IP FAX 1 receives the disconnection request (BYE) in step S112, it transmits a successful response (200 OK) to IP FAX 2 via the IP exchange 150 in step S113. In step S114, IP FAX 2 receives the successful response (200 OK), and ends the established session.

<Processing in IP FAX Apparatus on Transmitting Side>

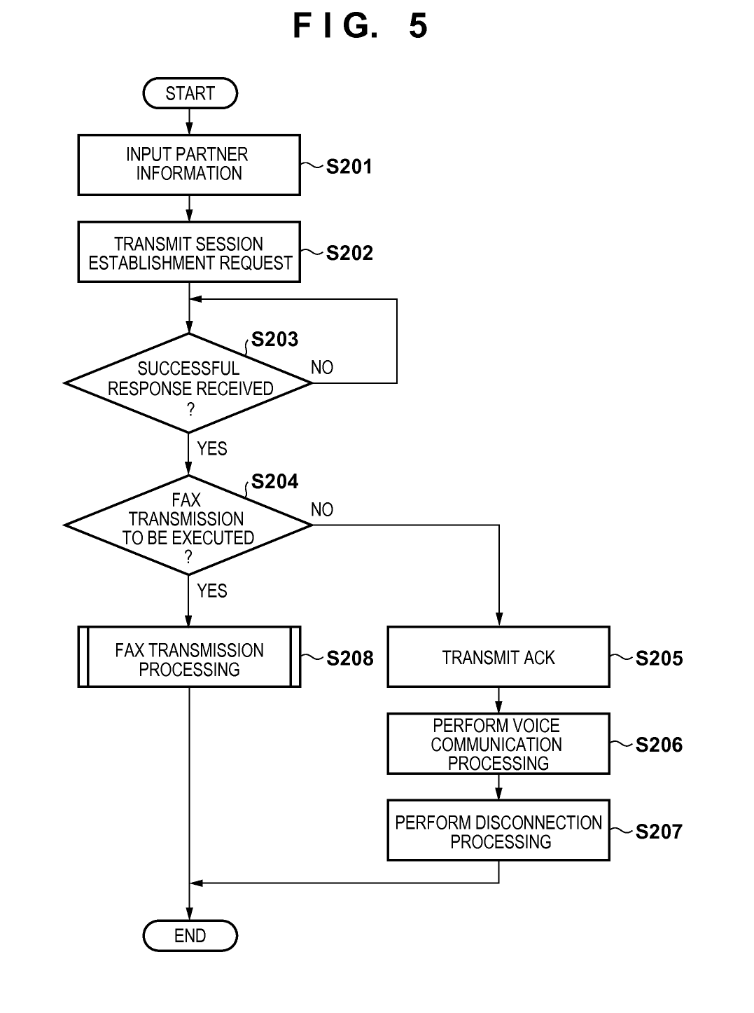

FIG. 5 is a flowchart showing the procedures of call connection processing to be executed in the IP FAX apparatuses 100 and 200 (IP FAX 1 and IP FAX 2) according to the embodiment. Here, processing to be executed by IP FAX 1 when performing FAX transmission from IP FAX 1 to IP FAX 2 will be explained. Note that processing of each step shown in FIG. 5 is implemented in IP FAX 1 when the CPU 101 reads out, to the RAM 103, a program stored in the ROM 102, and executes it.

First, in step S201, the CPU 101 accepts input of partner information by an operation input from the operator via the operation unit 115. Assume that the CPU 101 accepts input of a partner telephone number as partner information. Note that the input partner information may be information representing a partner apparatus for FAX transmission via the IP network 140, or information representing a partner apparatus for voice communication via the IP network 140. In this manner, the CPU 101 functions as an example of an acceptance unit in step S201. Then, in step S202, the CPU 101 transmits, from the LAN I/F 111 via the IP network 140, an SIP session establishment request (INVITE) to, as a transmission destination, a partner apparatus represented by the input partner information. After that, the CPU 101 advances the process to step S203.

In step S203, the CPU 101 stands by until it receives a successful response, by determining whether it has received, from the partner apparatus on the receiving side, a successful response (200 OK) representing that the session establishment request has succeeded (that is, FAX transmission can be received).

If the CPU 101 receives the successful response (200 OK) (“YES” in step S203), it advances the process to step S204.

In step S204, the CPU 101 determines whether the session establishment request (INVITE) has been performed as an originating operation for voice communication or as an originating operation for FAX transmission. For example, if the CPU 101 has performed the session establishment request for a FAX transmission job, it determines that the session establishment request has been performed as an originating operation for FAX transmission (“YES” in step S204), and advances the process to step S208. On the other hand, if the SLIC 109 detects an off-hook signal and selection signal output from the telephone 110, the CPU 101 determines that the session establishment request has been performed as an originating operation for voice communication (“NO” in step S204), and advances the process to step S205.

(Voice Communication Processing)

The CPU 101 transmits an acknowledgement (ACK) to the partner apparatus in step S205, and starts VoIP voice communication processing with the partner apparatus in step S206. In this fashion, when performing voice communication processing, the CPU 101 need not prompt the operator to confirm partner information, unlike FAX transmission. This is because, in origination for voice communication, even if the operator erroneously starts a voice communication with a partner apparatus not intended by the operator, the operator himself suffices to tell that this is an incorrect number, in a conversation with the operator of the partner apparatus, and end the voice communication. After the end of the voice communication, the CPU 101 transmits, to the partner apparatus, a disconnection request (BYE) for the established session, and upon receiving a successful response (200 OK) from the partner apparatus, performs disconnection processing of the session in step S207. As a result, the CPU 101 ends the voice communication processing.

(FAX Transmission Processing)

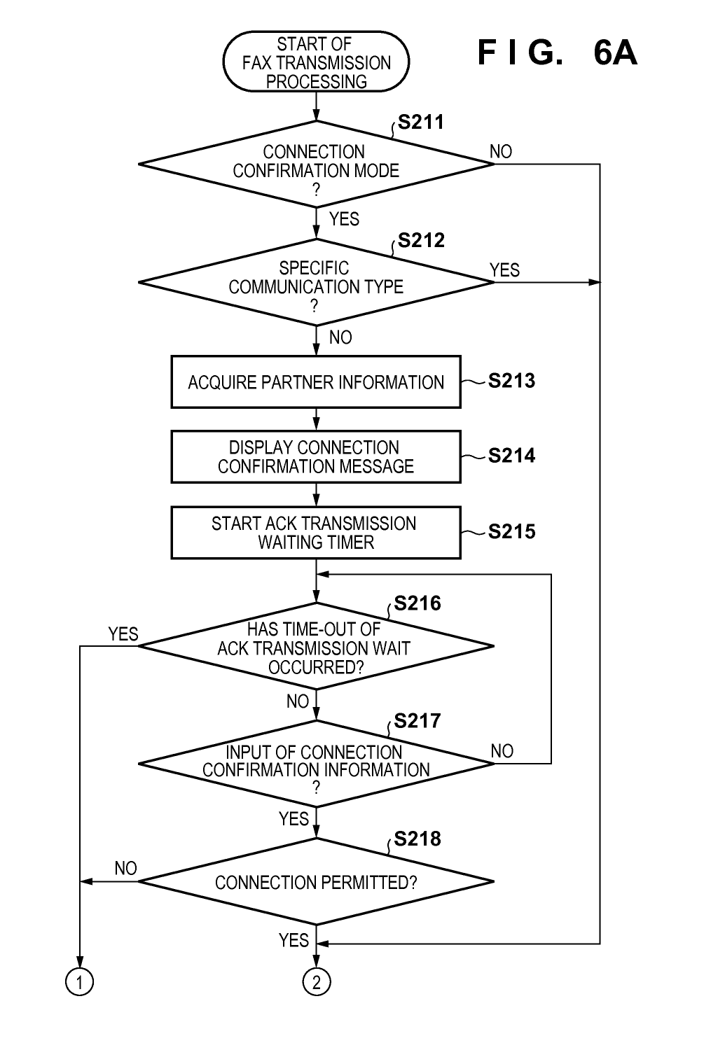

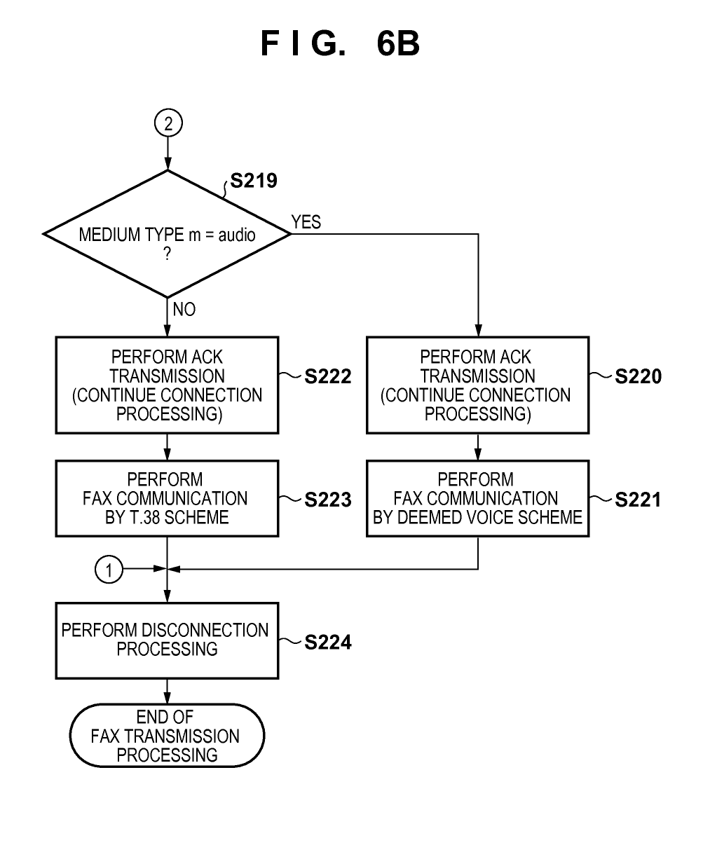

If the CPU 101 advances the process from step S204 to step S208, it performs FAX transmission processing (steps S211 to S224) according to procedures shown in FIGS. 6A and 6B. In step S211, the CPU 101 determines whether or not a connection confirmation mode has been set in advance. In the connection confirmation mode, connection confirmation processing is performed, in the IP FAX apparatus 100, to prompt the operator to confirm partner information and accept permission/inhibition of connection to a partner apparatus from the operator. If the CPU 101 determines that the connection confirmation mode has been set, it advances the process to step S212. If the CPU 101 determines that the connection confirmation mode has not been set, it advances the process to step S219.

In step S212, the CPU 101 determines whether or not to perform a specific communication type of transmission. The specific communication type of transmission is, for example, timer transmission to perform FAX transmission at a preset time, broadcast to perform FAX transmission simultaneously to a plurality of partner apparatuses, or retransmission of FAX transmission owing to generation of a communication error. These transmissions can be executed at the timing when the operator is absent in front of the IP FAX apparatus 100. In such a case, even if the operation unit 115 displays acquired partner information, the operator cannot be prompted to confirm the partner information. For this reason, if the CPU 101 determines in step S212 to perform a specific communication type of transmission, it advances the process to step S219 to perform FAX transmission without executing connection confirmation processing. In contrast, if the CPU 101 determines not to perform a specific communication type of transmission, it advances the process to step S213. The above-described operation can avoid unnecessary execution of connection confirmation processing in a situation in which the operator may be absent in front of the IP FAX apparatus 100.

In step S213, the CPU 101 acquires partner information from an SIP message corresponding to the successful response (200 OK) received from the partner apparatus. Further, in step S214, the CPU 101 displays the acquired partner information on the operation unit 115, for example, as shown in FIG. 4, and prompts the operator to confirm the partner information (whether or not the partner apparatus is one intended by the operator). At this time, the CPU 101 starts an ACK transmission waiting timer in step S215, and waits for input of connection confirmation information by the operator (steps S216 to S218).

In step S216, if the operator has not input connection confirmation information and a time-out of the ACK transmission waiting timer occurs (“YES” in step S216), the CPU 101 regards it as inhibition of connection, and advances the process to step S224. In step S224, the CPU 101 transmits a session establishment cancel request (CANCEL) to the partner apparatus. In this way, if a predetermined time has elapsed without permitting execution of FAX transmission by the operator after the operation unit 115 displays the partner information, the CPU 101 transmits a cancel request to the partner apparatus. If the CPU 101 receives a successful response (200 OK) from the partner apparatus in response to the cancel request (CANCEL), it cancels the session and ends the process. It can therefore be prevented from unnecessarily continuing the standby state for connection confirmation processing in a situation in which, for example, the operator is away from the IP FAX apparatus 100.

If the operator has not input connection confirmation information in step S217 (“NO” in step S217), the CPU 101 repeats the determination processing in step S216. If the operator has input connection confirmation information (“YES” in step S217), it advances the process to step S218. If the operator permits connection (that is, execution of FAX transmission) based on confirmation of the partner information in step S218, the CPU 101 advances the process to step S219. If the operator does not permit connection (that is, inhibits execution of FAX transmission), the CPU 101 advances the process to step S224. In step S224, the CPU 101 transmits a session establishment cancel request (CANCEL) to the partner apparatus. If the CPU 101 receives a successful response (200 OK) from the partner apparatus in response to the cancel request (CANCEL), it cancels the session and ends the process. In this manner, the operator can confirm partner information in the IP FAX apparatus 100 on the transmitting side without mounting a new function in the partner apparatus in FAX transmission.

In steps S219 to S223, the CPU 101 finally establishes a session corresponding to the session establishment request, and executes FAX transmission to the partner apparatus in this session. More specifically, in step S219, the CPU 101 performs FAX transmission to the partner apparatus by a scheme corresponding to a preset medium type m. The medium type m is set in advance in the IP FAX apparatus 100. Note that the CPU 101 describes the preset medium type m in the session establishment request (step S202), thereby notifying the partner apparatus of it.

If “audio” is used as the medium type m in step S219 (“YES” in step S219), the CPU 101 advances the process to step S220. The CPU 101 transmits an acknowledgement (ACK) to the partner apparatus to establish a session for the medium type “audio” in step S220, and performs FAX transmission (G3 FAX transmission) by the deemed voice scheme in step S221. The deemed voice scheme is equivalent to a scheme of deeming a G3 FAX signal as a voice and performing FAX communication on an IP network. After the end of FAX transmission, the CPU 101 advances the process to step S224.

If “image” or “application” is used as the medium type m in step S219 (“NO” in step S219), the CPU 101 advances the process to step S222. The CPU 101 transmits an acknowledgement (ACK) to the partner apparatus to establish a session for the medium type “image” or “application” in step S222, and performs FAX transmission by the T.38 scheme in step S223. After the end of FAX transmission, the CPU 101 advances the process to step S224.

In step S224, the CPU 101 transmits a disconnection request (BYE) for the established session to the partner apparatus, and upon receiving a successful response (200 OK) from the partner apparatus, performs disconnection processing of the session, thereby ending the FAX transmission processing.

As described above, when the IP FAX apparatus 100 according to the embodiment accepts input of partner information representing a partner apparatus (for example, the IP FAX apparatus 200) in FAX transmission via an IP network, it transmits an SIP session establishment request to the partner apparatus. Upon receiving a response (provisional response or successful response) to the session establishment request from the partner apparatus, the IP FAX apparatus 100 prompts the operator to confirm partner information contained in the response before the start of FAX transmission. The IP FAX apparatus 100 accepts, from the operator, input of connection confirmation information representing whether or not to permit execution of FAX transmission by, for example, displaying confirmation of the partner information on the operation unit 115. Further, the IP FAX apparatus 100 controls execution of FAX transmission based on the input connection confirmation information.

According to the embodiment, partner information can be acquired from a partner apparatus based on standard SIP call connection procedures, and the operator can be prompted to confirm the acquired information. The operator can confirm partner information without the need to mount a new function in a partner apparatus in FAX transmission. Therefore, confirmation of partner information before FAX transmission can be implemented by simpler procedures, and execution of FAX transmission can be appropriately controlled based on the result of confirmation.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-171708, filed Aug. 21, 2013, which is hereby incorporated by reference herein in its entirety.

What is claimed is:

1. A communication apparatus capable of executing SIP facsimile (FAX) transmission via an IP network, comprising:
an acceptance unit configured to accept, from an operator, input of partner information representing a partner apparatus in the FAX transmission via the IP network;
a transmission unit configured to transmit an SIP session establishment request via the IP network to the partner apparatus represented by the input partner information; and
a confirmation unit configured to, in a case where a response to the session establishment request is received from the partner apparatus, prompt the operator to confirm partner information contained in the response before a start of the FAX transmission.

2. The communication apparatus according to claim 1, further comprising a control unit configured to, in a case where the operator permits execution of the FAX transmission based on the confirmation of the partner information, establish a session between the communication apparatus and the partner apparatus by transmitting an acknowledgement to the response, and execute the FAX transmission to the partner information in the session.

3. The communication apparatus according to claim 2, wherein in a case where the operator inhibits the execution of the FAX transmission based on the confirmation of the partner information, the control unit transmits a session establishment cancel request to the partner apparatus.

4. The communication apparatus according to claim 2, wherein the confirmation unit displays the partner information contained in the response on a display unit of the communication apparatus to prompt the operator to confirm the partner information contained in the response.

5. The communication apparatus according to claim 4, wherein in a case where a predetermined time has elapsed without the operator permitting the execution of the FAX transmission after displaying the partner information on the display unit, the control unit transmits a session establishment cancel request to the partner apparatus.

6. The communication apparatus according to claim 2, wherein
the acceptance unit can accept, from the operator, partner information representing a partner apparatus in voice communication via the IP network,
in a case where the transmission unit transmits the session establishment request to the partner apparatus in order to start the voice communication,
the confirmation unit does not prompt the operator to confirm the partner information, and
the control unit establishes a session between the communication apparatus and the partner apparatus by transmitting an acknowledgement in response to reception of a response to the session establishment request, and executes the FAX transmission to the partner apparatus in the session.

7. The communication apparatus according to claim 2, wherein
in a case where performing one of timer transmission to perform the FAX transmission at a preset time, broadcast to perform the FAX transmission simultaneously to a plurality of partner apparatuses, and retransmission of the FAX transmission owing to generation of a communication error,
the confirmation unit does not prompt the operator to confirm the partner information, and
the control unit establishes a session between the communication apparatus and the partner apparatus by transmitting an acknowledgement in response to reception of a response to the session establishment request, and executes the FAX transmission to the partner apparatus in the session.

8. The communication apparatus according to claim 1, wherein the response includes one of a provisional response representing that the session establishment request received from the partner apparatus in response to the session establishment request is being processed, and a successful response representing that the FAX transmission is receivable.

9. A method of controlling a communication apparatus capable of executing SIP facsimile (FAX) transmission via an IP network, comprising steps of:
accepting, from an operator, input of partner information representing a partner apparatus in the FAX transmission via the IP network;
transmitting a session establishment request by SIP via the IP network to the partner apparatus represented by the input partner information; and
in a case where a response to the session establishment request is received from the partner apparatus, prompting the operator to confirm partner information contained in the response before a start of the FAX transmission.

10. A computer-readable storage medium storing a computer program for causing a computer to execute steps of a method of controlling a communication apparatus capable of executing SIP facsimile (FAX) transmission via an IP network, comprising steps of:
accepting, from an operator, input of partner information representing a partner apparatus in the FAX transmission via the IP network;
transmitting a session establishment request by SIP via the IP network to the partner apparatus represented by the input partner information; and
in a case where a response to the session establishment request is received from the partner apparatus, prompting the operator to confirm partner information contained in the response before a start of the FAX transmission.
